(19) United States
(12) Patent Application Publication
(10) Pub. No.: US 2022/0250362 A1
(43) Pub. Date: Aug. 11, 2022

(54) MULTILAYER SHEET

(71) Applicant: Eastman Chemical Company, Kingsport, TN (US)

(72) Inventors: James Wesley Peer, Kingsport, TN (US); Glen Petrie, Oregaon, WI (US); Kevin Douglas Wagner, Kingsport, TN (US)

(73) Assignee: Eastman Chemical Company, Kingsport, TN (US)

(21) Appl. No.: 17/597,703

(22) PCT Filed: Jul. 31, 2020
(86) PCT No.: PCT/US2020/044371

§ 371 Date: Jan. 19, 2022

Related U.S. Application Data
(60) Provisional application No. 62/882,185, filed on Aug. 2, 2019.

(51) Int. Cl. B32B 27/08; B32B 27/36; A61C 7/08

(52) U.S. Cl. CPC B32B 27/08; B32B 27/36; A61C 7/08; B32B 2307/732; B32B 2307/5825; B32B 2307/414; B32B 2535/00; B32B 2250/03; B32B 2250/244; B32B 2250/40; B32B 2307/546

(57) ABSTRACT

Provided are copolyester multilayer film/sheet structures which exhibit improved durability and customizable modulus properties which can be useful in many applications, including formed articles for use in the dental appliance market.

### FIELD OF THE INVENTION

This invention belongs generally to the field of thermoplastic polymers. In particular, it relates to polymeric sheets useful in the manufacture three dimensional thermoformed articles, such as dental appliances.

### BACKGROUND OF THE INVENTION

Traditionally, metal braces have been used to reposition teeth for improved function or appearance. In recent years, metal braces have been supplanted in many cases by plastic aligners. Aligners are thermoformed appliances which fit over the patient's teeth, designed to gradually move them to a desired position. Aligners must be stiff enough to exert an initial force on the teeth, able to maintain a sufficient force over a period of time and be durable (resist cracking). Aligners can be made from a monolayer plastic sheet, but multilayer sheet (consisting of two or more distinct layers of plastic) allows more freedom to tailor properties to specific needs.

### SUMMARY OF THE INVENTION

The invention is as set forth in the appended claims. In general, the invention relates to multilayer film/sheet structures which exhibit improved durability and customizable modulus properties which can be useful in many applications, including thermoformed articles for use in the dental appliance market. The modulus can be tailored to fit the needs of the end user by altering the material selection or the thickness of the layers. These structures can be produced through extrusion, lamination, or other means known to those skilled in the art.

In an aspect, multilayer film/sheet structures are provided that have a combination of good tear force and force retention properties, while maintaining sufficiently high flex modulus (for the overall sheet structure).

### DETAILED DESCRIPTION OF THE INVENTION

The term “film”, as used herein, includes both film and sheet, and is intended to have its commonly accepted meaning in the art. The term “sheet” is also understood to include both single layer and multilayer sheets.

As used herein, the singular forms “a”, “an”, and “the” include their plural referents unless the context clearly dictates otherwise. The terms “containing” or “including” are intended to be synonymous with the term “comprising”, meaning that at least the named compound, element, particle, or method step, etc., is present in the composition or article but does not exclude the presence of other compounds, materials, method steps, etc., even if the other such compounds, material, particles, method steps, etc., have the same function as what is named, unless expressly excluded in the claims.

In a first aspect, the invention provides a multilayer sheet comprising at least three layers, said three layers comprising two outer layers and a core layer, wherein
(A) said outer layers are the same or are different and comprise a polyester comprising:
   (a) a dicarboxylic acid component comprising:
      i) 70 to 100 mole % of terephthalic acid residues; and
      ii) 0 to 30 mole % of aromatic and/or aliphatic dicarboxylic acid residues having up to 20 carbon atoms; and
   (b) a glycol component comprising:
      i) 10 to 40 mole % of 2,2,4,4-tetramethyl-1,3-cyclobutanediol residues;
      ii) 0 to 90 mole % of 1,4-cyclohexanedimethanol residues; and
      iii) 0 to 90 mole % of ethylene glycol residues; and having an inherent viscosity of about 0.4 to about 0.9 dL/g as determined in 60/40 (wt/wt) phenol/tetrachloroethane at a concentration of 0.5 g/100 ml at 25° C.; and
(B) a core layer which comprises a polyester which is other than the polyester in said outer layer, and wherein the overall thickness of the sheet is between 100 and 3000 microns.

In another embodiment,
(A) said outer layers are the same or are different and comprise a polyester comprising:
   (a) a dicarboxylic acid component comprising:
      i) 70 to 100 mole % of terephthalic acid residues; and
      ii) 0 to 30 mole % of aromatic and/or aliphatic dicarboxylic acid residues having up to 20 carbon atoms; and
   (b) a glycol component comprising:
      i) 10 to 40 mole % of isosorbide residues;
      ii) 0 to 90 mole % of 1,4-cyclohexanedimethanol residues; and
      iii) 0 to 90 mole % of ethylene glycol residues; and having an inherent viscosity of about 0.4 to about 1.2 dL/g as determined in 60/40 (wt/wt) phenol/tetrachloroethane at a concentration of 0.5 g/100 ml at 25° C.; and
(B) a core layer which comprises a polyester which is other than the polyester in said outer layer, and wherein the overall thickness of the sheet is between 100 and 3000 microns.

In another embodiment,
(A) said outer layers are the same or are different and comprise a polyester comprising:
   (a) a dicarboxylic acid component comprising:
      i) 90 to 100 mole % of terephthalic acid residues;
      ii) 0 to 10 mole % of aromatic and/or aliphatic dicarboxylic acid residues having up to 20 carbon atoms; and
   (b) a glycol component comprising:
      i) 10 to 40 mole % of 2,2,4,4-tetramethyl-1,3-cyclobutanediol residues;
      ii) 60 to 90 mole % of 1,4-cyclohexanedimethanol residues; and
has an inherent viscosity of about 0.5 to about 0.9 dL/g as determined in 60/40 (wt/wt) phenol/tetrachloroethane at a concentration of 0.5 g/100 ml at 25° C.

In another embodiment, the inherent viscosity of said outer layer is between about 0.6 and 0.8 dL/g.

In another embodiment,
(A) said outer layers are the same or are different and comprise a polyester comprising:
   (a) a dicarboxylic acid component comprising:
      i) 90 to 100 mole % of terephthalic acid residues;
      ii) 0 to 10 mole % of aromatic and/or aliphatic dicarboxylic acid residues having up to 20 carbon atoms; and
   (b) a glycol component comprising:
      i) 10 to 40 mole % of 2,2,4,4-tetramethyl-1,3-cyclobutanediol residues;
      ii) 60 to 90 mole % of ethylene glycol residues; and
has an inherent viscosity of about 0.4 to about 0.9 dL/g as determined in 60/40 (wt/wt) phenol/tetrachloroethane at a concentration of 0.5 g/100 ml at 25° C. In another embodiment, the inherent viscosity of said outer layer is between about 0.5 and 0.7 dL/g.

In one embodiment, the core layer is a copolyester which is different from the outer layers, and comprises a dicarboxylic acid component comprising residues of trans-1,4-cyclohexane dicarboxylate and a diol component comprising residues of 1,4-cyclohexanedimethanol and poly(tetramethylene ether)glycol.

In another embodiment, the core layer comprises a copolyester comprising
(a) a dicarboxylic acid component comprising:
   i) 90 to100 mole % of trans-1,4-cyclohexane dicarboxyic acid residues;
   ii) 0 to 10 mole % of aromatic and/or aliphatic dicarboxylic acid residues having up to 20 carbon atoms; and
(b) a glycol component comprising:
   i) 95 to 80 mole % of 1,4-cyclohexanedimethanol residues, and
   ii) 5 to 20 mole % of poly(tetramethylene ether)glycol residues; and
has an inherent viscosity of about 0.9 to about 1.4 dL/g as determined in 60/40 (wt/wt) phenol/tetrachloroethane at a concentration of 0.5 g/100 ml at 25° C. In another embodiment, the inherent viscosity ranges from about 1.02 to about 1.26.

In another embodiment, the core layer comprises a copolyester comprising:
(a) a dicarboxylic acid component comprising:
   i) 90 to100 mole % of trans-1,4-cyclohexane dicarboxylic acid residues;
   ii) 0 to 10 mole % of aromatic and/or aliphatic dicarboxylic acid residues having up to 20 carbon atoms; and
(b) a glycol component comprising:
   i) 15 to 65 mole % of 1,4-cyclohexanedimethanol residues, and
   ii) 85 to 35 mole % ethylene glycol residues;
and has an inherent viscosity of about 0.4 to about 0.8 dL/g as determined in 60/40 (wt/wt) phenol/tetrachloroethane at a concentration of 0.5 g/100 ml at 25° C. In this embodiment, the total moles of the glycol component add up to 100 mole % and may further be comprised of 0 to 15 mole % of residues of diethylene glycol.

Examples of suitable outer layers depending on the application can include Eastman Tritan™ MP100 copolyester, available from Eastman Chemical Company. Examples of suitable core layer materials depending on the application can include Ecdel™ Elastomer 9966, and Eastar™ Copolyester 6763, available from Eastman Chemical Company.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically, the difunctional carboxylic acid can be a dicarboxylic acid and the difunctional hydroxyl compound can be a dihydric alcohol such as, for example, glycols. The term “glycol” as used herein includes, but is not limited to, diols, glycols, and/or multifunctional hydroxyl compounds. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester.

In one embodiment, terephthalic acid may be used as the starting material. In another embodiment, dimethyl terephthalate may be used as the starting material. In another embodiment, mixtures of terephthalic acid and dimethyl terephthalate may be used as the starting material and/or as an intermediate material.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided herein, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % 2,2,4,4-tetramethyl-1,3-cyclobutanediol, based on the total diol residues, means the polyester contains 30 mole % 2,2,4,4-tetramethyl-1,3-cyclobutanediol residues out of a total of 100 mole % diol residues. Thus, there are 30 moles of 2,2,4,4-tetramethyl-1,3-cyclobutanediol residues among every 100 moles of diol residues.

For the desired polyester, the molar ratio of cis/trans 2,2,4,4-tetramethyl-1,3-cyclobutanediol can vary from the pure form of each or mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 30 to 70 mole % cis and 70 to 30% trans; or 40 to 60 mole % cis and 60 to 40 mole % trans; or 50 to 70 mole % trans and 50 to 30% cis or 50 to 70 mole % cis and 50 to 30% trans; or 60 to 70 mole % cis and 30 to 40 mole % trans; or greater than 70 mole cis and less than 30 mole % trans; wherein the total sum of the mole percentages for cis- and trans-2,2,4,4-tetramethyl-1,3-cyclobutanediol is equal to 100 mole %. The molar ratio of cis/trans 1,4-cyclohexanedimethanol can vary within the range of 50/50 to 0/100, such as between 40/60 to 20/80.

In certain embodiments of the outer layer copolyester, terephthalic acid or an ester thereof, such as, for example, dimethyl terephthalate, or a mixture of terephthalic acid and an ester thereof, makes up most or all of the dicarboxylic acid component used to form the polyesters useful in the invention. In certain embodiments, terephthalic acid residues can make up a portion or all of the dicarboxylic acid component used to form the present polyester at a concentration of at least 70 mole %, such as at least 80 mole %, at least 90 mole %, at least 95 mole %, at least 99 mole %, or 100 mole %. In certain embodiments, higher amounts of terephthalic acid can be used in order to produce a higher impact strength polyester. In one embodiment, dimethyl terephthalate is part, or all of the dicarboxylic acid component used to make the polyesters useful in the present invention. As used herein, the terms “terephthalic acid” and “dimethyl terephthalate” are used interchangeably.

In addition to terephthalic acid, the dicarboxylic acid component of the copolyester useful in outer layer can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters useful in the invention can be further modified with up to 10 mole %, such as up to 5 mole % or up to 1 mole % of one or more aliphatic dicarboxylic acids containing up to 20 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

The 1,4-cyclohexanedimethanol may be cis, trans, or a mixture thereof, for example a cis/trans ratio of 60:40 to 40:60. In another embodiment, the trans-1,4-cyclohexanedimethanol can be present in an amount of 60 to 80 mole %.

In certain embodiments of the outer layer copolyester, the glycol component of the copolyesters described above can contain up to 35 mole % of one or more modifying glycols which are not 2,2,4,4-tetramethyl-1,3-cyclobutanediol or 1,4-cyclohexanedimethanol.

Modifying glycols useful in the polyesters can be diols other than 2,2,4,4,-tetramethyl-1,3-cyclobutanediol and 1,4-cyclohexanedimethanol and may contain 2 to 16 carbon atoms. Examples of suitable modifying glycols include, but are not limited to, ethylene glycol, 1,2-propanediol, 1,3-propanediol, neopentyl glycol, 1,4-butanediol, 1,5-pentanediol, 1,6-hexanediol, p-xylene glycol, isosorbide or mixtures thereof. In one embodiment, the modifying glycol is ethylene glycol. In another embodiment, the modifying glycols are 1,3-propanediol and/or 1,4-butanediol. In another embodiment, ethylene glycol is excluded as a modifying diol. In another embodiment, 1,3-propanediol and 1,4-butanediol are excluded as modifying diols. In another embodiment, 2,2-dimethyl-1,3-propanediol is excluded as a modifying diol.

The polyesters of the invention can further comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. The polyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

In addition, the polyester compositions useful in this invention may also contain from 0.01 to 25% by weight or 0.01 to 20% by weight or 0.01 to 15% by weight or 0.01 to 10% by weight or 0.01 to 5% by weight of the total weight of the polyester composition of common additives such as colorants, dyes, slip or release agents, and/or stabilizers, including but not limited to thermal or hydrolytic stabilizers.

In certain embodiments, where the outer layers comprise copolyesters containing TMCD and CHDM residues, the glycol component for the polyesters can include but is not limited to at least one of the following combinations of ranges: 10 to 40 mole % 2,2,4,4-tetramethyl-1,3-cyclobutanediol and 60 to 90 mole % 1,4-cyclohexanedimethanol; 10 to 35 mole % 2,2,4,4-tetramethyl-1,3-cyclobutanediol and 65 to 90 mole % 1,4-cyclohexanedimethanol; 10 to less than 35 mole % 2,2,4,4-tetramethyl-1,3-cyclobutanediol and greater than 65 up to 90 mole % 1,4-cyclohexanedimethanol; 10 to 30 mole % 2,2,4,4-tetramethyl-1,3-cyclobutanediol and 70 to 90 mole % 1,4-cyclohexanedimethanol; 10 to 25 mole % 2,2,4,4-tetramethyl-1,3-cyclobutanediol and greater than 75 to 90 mole % 1,4-cyclohexanedimethanol; 11 to 25 mole % 2,2,4,4-tetramethyl-1,3-cyclobutanediol and 75 to 89 mole % 1,4-cyclohexanedimethanol; 12 to 25 mole % 2,2,4,4-tetramethyl-1,3-cyclobutanediol and 75 to 88 mole % 1,4-cyclohexanedimethanol; and 13 to 25 mole % 2,2,4,4-tetramethyl-1,3-cyclobutanediol and 75 to 87 mole % 1,4-cyclohexanedimethanol.

In other embodiments, the glycol component for the polyesters can include but is not limited to at least one of the following combinations of ranges: 15 to 40 mole % 2,2,4,4-tetramethyl-1,3-cyclobutanediol and 60 to 85 mole % 1,4-cyclohexanedimethanol; 15 to 35 mole % 2,2,4,4-tetramethyl-1,3-cyclobutanediol and 65 to 85 mole % 1,4-cyclohexanedimethanol; 15 to 30 mole % 2,2,4,4-tetramethyl-1,3-cyclobutanediol and 70 to 85 mole % 1,4-cyclohexanedimethanol; 15 to 25 mole % 2,2,4,4-tetramethyl-1,3-cyclobutanediol and 75 to 85 mole % 1,4-cyclohexanedimethanol; 15 to 20 mole % 2,2,4,4-tetramethyl-1,3-cyclobutanediol and 75 to 80 mole % 1,4-cyclohexanedimethanol; and 17 to 23 mole % 2,2,4,4-tetramethyl-1,3-cyclobutanediol and 77 to 83 mole % 1,4-cyclohexanedimethanol.

In other embodiments, where the outer layers comprise copolyesters containing TMCD and CHDM residues, the glycol component for the polyesters can include but is not limited to at least one of the following combinations of ranges: 20 to 40 mole % 2,2,4,4-tetramethyl-1,3-cyclobutanediol and 60 to 80 mole % 1,4-cyclohexanedimethanol; 20 to 35 mole % 2,2,4,4-tetramethyl-1,3-cyclobutanediol and 65 to 80 mole % 1,4-cyclohexanedimethanol; 20 to 30 mole % 2,2,4,4-tetramethyl-1,3-cyclobutanediol and 70 to 80 mole % 1,4-cyclohexandimethanol; and 20 to 25 mole % 2,2,4,4-tetramethyl-1,3-cyclobutanediol and 75 to 80 mole % 1,4-cyclohexanedimethanol.

In other embodiments, where the outer layers comprise copolyesters containing TMCD and CHDM residues, the glycol component for the polyesters can include but is not limited to at least one of the following combinations of ranges: 25 to 40 mole % 2,2,4,4-tetramethyl-1,3-cyclobutanediol and 60 to 75 mole % 1,4-cyclohexanedimethanol; 25 to 35 mole % 2,2,4,4-tetramethyl-1,3-cyclobutanediol and 65 to 75 mole % 1,4-cyclohexanedimethanol; and 25 to 30 mole % 2,2,4,4-tetramethyl-1,3-cyclobutanediol and 70 to 75 mole % 1,4-cyclohexanedimethanol; 30 to 40 mole % 2,2,4,4-tetramethyl-1,3-cyclobutanediol and 60 to 70 mole % 1,4-cyclohexanedimethanol; 30 to 35 mole % 2,2,4,4-tetramethyl-1,3-cyclobutanediol and 65 to 70 mole % 1,4-cyclohexanedimethanol.

In certain embodiments, where the outer layers comprise copolyesters containing TMCD and CHDM residues, the copolyesters can contain less than 15 mole % ethylene glycol residues, such as, for example, 0.01 to less than 15 mole % ethylene glycol residues. In embodiments, the polyesters useful in the invention contain less than 10 mole %, or less than 5 mole %, or less than 4 mole %, or less than 2 mole %, or less than 1 mole % ethylene glycol residues, such as, for example, 0.01 to less than 10 mole %, or 0.01 to less than 5 mole %, or 0.01 to less than 4 mole %, or 0.01 to less than 2 mole %, or 0.01 to less than 1 mole %, ethylene glycol residues. In one embodiment, the copolyesters useful in the invention contain no ethylene glycol residues.

In certain embodiments, where the outer layers comprise copolyesters containing isosorbide and CHDM residues, the glycol component for the polyesters can include but is not limited to at least one of the following combinations of ranges: 10 to 40 mole % isosorbide, 20 to 80 mole % 1,4-cyclohexanedimethanol, and 10 to 40 mole % EG; 10 to 35 mole % isosorbide, 25 to 80 mole % 1,4-cyclohexanedimethanol, and 10 to 40 mole % EG; 10 to less than 35 mole % isosorbide, greater than 25 up to 80 mole % 1,4-cyclohexanedimethanol, and 10 to 40 mole % EG; 10 to 30 mole % isosorbide, 30 to 80 mole % 1,4-cyclohexanedimethanol, and 10 to 40 mole % EG; 10 to 25 mole % isosorbide, 35 to 80 mole % 1,4-cyclohexanedimethanol, and 10 to 40 mole % EG; 11 to 25 mole % isosorbide, 35 to 79 mole % 1,4-cyclohexanedimethanol, and 10 to 40 mole % EG; 12 to 25 mole % isosorbide, 35 to 78 mole % 1,4-cyclohexanedimethanol, and 10 to 40 mole % EG; and 13 to 25 mole % isosorbide, 35 to 77 mole % 1,4-cyclohexanedimethanol, and 10 to 40 mole % EG.

In other embodiments, the glycol component for the polyesters can include but is not limited to at least one of the following combinations of ranges: 15 to 40 mole % isosorbide, 20 to 75 mole % 1,4-cyclohexanedimethanol, and 10 to 40 mole % EG; 15 to 35 mole % isosorbide, 25 to 75 mole % 1,4-cyclohexanedimethanol, and 10 to 40 mole % EG; 15 to 30 mole % isosorbide, 30 to 75 mole % 1,4-cyclohexanedimethanol, and 10 to 40 mole % EG; 15 to 25 mole % isosorbide, 35 to 75 mole % 1,4-cyclohexanedimethanol, and 10 to 40 mole % EG; 15 to 20 mole % isosorbide, 40 to 75 mole % 1,4-cyclohexanedimethanol, and 10 to 40 mole % EG; 17 to 23 mole % isosorbide, 37 to 73 mole % 1,4-cyclohexanedimethanol, and 10 to 40 mole % EG; 15 to 30 mole % isosorbide, 40 to 75 mole % 1,4-cyclohexanedimethanol, and 10 to 30 mole % EG; 20 to 30 mole % isosorbide, 40 to 65 mole % 1,4-cyclohexanedimethanol, and 15 to 30 mole % EG.

In other embodiments, the glycol component for the polyesters can include but is not limited to at least one of the following combinations of ranges: 10 to 30 mole % isosorbide, 40 to 65 mole % 1,4-cyclohexanedimethanol, and 30 to 45 mole % EG; 20 to 30 mole % isosorbide, 40 to 60 mole % 1,4-cyclohexanedimethanol, and 20 to 30 mole % EG; 20 to 35 mole % isosorbide, 40 to 55 mole % 1,4-cyclohexanedimethanol, and 20 to 30 mole % EG.

In embodiments, where the outer layers comprise copolyesters containing TMCD and EG residues, the polyesters can include a copolyester comprising: (a) diacid residues comprising from about 90 to 100 mole percent of TPA residues and from 0 to about 10 mole percent IPA residues; and (b) diol residues comprising at least 60 mole percent of EG residues and up to 40 mole percent of TMCD residues, wherein the copolyester comprises a total of 100 mole percent diacid residues and a total of 100 mole percent diol residues.

In embodiments, the copolyester comprises diol residues comprising from 10 to 40 mole percent TMCD residues and 60 to 90 mole percent EG residues. In embodiments, the copolyester comprises diol residues comprising 20 to 37 mole percent TMCD residues and 63 to 80 mole percent EG residues. In one embodiment, the copolyester comprises diol residues comprising 22 to 35 mole percent TMCD residues and 65 to 78 mole percent EG residues.

In certain embodiments, where the outer layers comprise copolyesters containing TMCD and EG residues, the copolyester comprises: a) a dicarboxylic acid component comprising: (i) 90 to 100 mole % terephthalic acid residues; and (ii) about 0 to about 10 mole % of aromatic and/or aliphatic dicarboxylic acid residues having up to 20 carbon atoms; and (b) a glycol component comprising: (i) about 10 to about 27 mole % 2,2,4,4-tetramethyl-1,3-cyclobutanediol (TMCD) residues; and (ii) about 90 to about 73 mole % ethylene glycol residues; and wherein the total mole % of the dicarboxylic acid component is 100 mole %, and wherein the total mole % of the glycol component is 100 mole %; and wherein the inherent viscosity (IV) of the polyester is from 0.50 to 0.8 dL/g as determined in 60/40 (wt/wt) phenol/tetrachloroethane at a concentration of 0.25 g/50 ml at 25° C.; and wherein the L* color values for the polyester is 90 or greater, as determined by the L*a*b* color system measured following ASTM D 6290-98 and ASTM E308-99, performed on polymer granules ground to pass a 1 mm sieve. In embodiments, the L* color values for the polyester is greater than 90, as determined by the L*a*b* color system measured following ASTM D 6290-98 and ASTM E308-99, performed on polymer granules ground to pass a 1 mm sieve.

In certain embodiments, the glycol component of the copolyester comprises: (i) about 15 to about 25 mole % 2,2,4,4-tetramethyl-1,3-cyclobutanediol (TMCD) residues; and (ii) about 85 to about 75 mole % ethylene glycol residues; or (i) about 20 to about 25 mole % 2,2,4,4-tetramethyl-1,3-cyclobutanediol (TMCD) residues; and (ii) about 80 to about 75 mole % ethylene glycol residues; or (i) about 21 to about 24 mole % 2,2,4,4-tetramethyl-1,3-cyclobutanediol (TMCD) residues; and (ii) about 86 to about 79 mole % ethylene glycol residues.

In embodiments, where the outer layers comprise copolyesters containing TMCD and EG residues, the copolyester has at least one of the following properties chosen from: a Tg of from about 90 to about 108° C. as measured by a TA 2100 Thermal Analyst Instrument at a scan rate of 20° C./min, a flexural modulus at 23° C. of greater than about 2000 MPa (290,000 psi) as defined by ASTM D790, and a notched Izod impact strength greater than about 25 J/m (0.47 ft-lb/in) according to ASTM D256 with a 10-mil notch using a ⅛-inch thick bar at 23° C. In one embodiment, the L* color values for the copolyester is 90 or greater, or greater than 90, as determined by the L*a*b* color system measured following ASTM D 6290-98 and ASTM E308-99, performed on polymer granules ground to pass a 1 mm sieve.

In one embodiment, where the outer layers comprise copolyesters containing TMCD and EG residues, the copolyester further comprises: (II) a catalyst/stabilizer component comprising: (i) titanium atoms in the range of 10-50 ppm based on polymer weight, (ii) optionally, manganese atoms in the range of 10-100 ppm based on polymer weight, and (iii) phosphorus atoms in the range of 10-200 ppm based on polymer weight. In one embodiment, the 2,2,4,4-tetramethyl-1,3-cyclobutanediol residues is a mixture comprising more than 50 mole % of cis-2,2,4,4-tetramethyl-1,3-cyclobutanediol residues and less than 50 mole % of trans-2,2,4,4-tetramethyl-1,3-cyclobutanediol residues.

In certain embodiments, where the outer layers comprise copolyesters containing TMCD and EG residues, the glycol component for the copolyesters can include but are not limited to at least one of the following combinations of ranges: about 10 to about 30 mole % 2,2,4,4-tetramethyl-1,3-cyclobutanediol and about 90 to about 70 mole % ethylene glycol; about 10 to about 27 mole % 2,2,4,4-tetramethyl-1,3-cyclobutanediol and about 90 to about 73 mole % ethylene glycol; about 15 to about 26 mole % 2,2,4,4-tetramethyl-1,3-cyclobutanediol and about 85 to about 74 mole % ethylene glycol; about 18 to about 26 mole % 2,2,4,4-tetramethyl-1,3-cyclobutanediol and about 82 to about 77 mole % ethylene glycol; about 20 to about 25 mole % 2,2,4,4-tetramethyl-1,3-cyclobutanediol and about 80 to about 75 mole % ethylene glycol; about 21 to about 24 mole % 2,2,4,4-tetramethyl-1,3-cyclobutanediol and about 79 to about 76 mole % ethylene glycol; or about 22 to about 24 mole % 2,2,4,4-tetramethyl-1,3-cyclobutanediol and about 78 to about 76 mole % ethylene glycol.

In certain embodiments, where the outer layers comprise copolyesters containing TMCD and EG residues, the copolyesters may exhibit at least one of the following inherent viscosities as determined in 60/40 (wt/wt) phenol/tetrachloroethane at a concentration of 0.25 g/50 ml at 25° C. from 0.50 to 0.8 dL/g; 0.55 to 0.75 dL/g; 0.57 to 0.73 dL/g; 0.58 to 0.72 dL/g; 0.59 to 0.71 dL/g; 0.60 to 0.70 dL/g; 0.61 to 0.69 dL/g; 0.62 to 0.68 dL/g; 0.63 to 0.67 dL/g; 0.64 to 0.66 dL/g; or about 0.65 dL/g.

In certain embodiments, where the outer layers comprise copolyesters containing TMCD and EG residues, the Tg of the copolyester can be chosen from one of the following ranges: 85 to 100° C.; 86 to 99° C.; 87 to 98° C.; 88 to 97° C.; 89 to 96° C.; 90 to 95° C.; 91 to 95° C.; 92 to 94° C.

In other embodiments, where the outer layers comprise copolyesters containing TMCD and EG residues, the copolyester comprises diol residues comprising 30 to 42 mole percent TMCD residues and 58 to 70 mole percent EG residues. In one embodiment, the copolyester comprises diol residues comprising 33 to 38 mole percent TMCD residues and 62 to 67 mole percent EG residues.

In certain embodiments, where the outer layers comprise copolyesters containing TMCD and EG residues, the copolyester comprises: a) a dicarboxylic acid component comprising: (i) 90 to 100 mole % terephthalic acid residues; and (ii) about 0 to about 10 mole % of aromatic and/or aliphatic dicarboxylic acid residues having up to 20 carbon atoms; and (b) a glycol component comprising: (i) about 30 to about 40 mole % 2,2,4,4-tetramethyl-1,3-cyclobutanediol (TMCD) residues; and (ii) about 70 to about 60 mole % ethylene glycol residues; and wherein the total mole % of the dicarboxylic acid component is 100 mole %, and wherein the total mole % of the glycol component is 100 mole %; and wherein the inherent viscosity (IV) of the polyester is from 0.50 to 0.70 dL/g as determined in 60/40 (wt/wt) phenol/tetrachloroethane at a concentration of 0.25 g/50 ml at 25° C.; and wherein the L* color values for the polyester is 90 or greater, as determined by the L*a*b* color system measured following ASTM D 6290-98 and ASTM E308-99, performed on polymer granules ground to pass a 1 mm sieve. In embodiments, the L* color values for the polyester is greater than 90, as determined by the L*a*b* color system measured following ASTM D 6290-98 and ASTM E308-99, performed on polymer granules ground to pass a 1 mm sieve.

In certain embodiments, where the outer layers comprise copolyesters containing TMCD and EG residues, the glycol component comprises: (i) about 32 to about 40 mole % 2,2,4,4-tetramethyl-1,3-cyclobutanediol (TMCD) residues, and (ii) about 68 to about 60 mole % ethylene glycol residues; or (i) about 34 to about 40 mole % 2,2,4,4-tetramethyl-1,3-cyclobutanediol (TMCD) residues, and (ii) about 66 to about 60 mole % ethylene glycol residues; or (i) greater than 34 to about 40 mole % 2,2,4,4-tetramethyl-1,3-cyclobutanediol (TMCD) residues, and (ii) less than 66 to about 60 mole % ethylene glycol residues; or (i) 34.2 to about 40 mole % 2,2,4,4-tetramethyl-1,3-cyclobutanediol (TMCD) residues, and (ii) 65.8 to about 60 mole % ethylene glycol residues; or (i) about 35 to about 39 mole % 2,2,4,4-tetramethyl-1,3-cyclobutanediol (TMCD) residues, and (ii) about 65 to about 61 mole % ethylene glycol residues; or (i) about 36 to about 37 mole % 2,2,4,4-tetramethyl-1,3-cyclobutanediol (TMCD) residues; and (ii) about 64 to about 63 mole % ethylene glycol residues.

In certain embodiments, where the outer layers comprise copolyesters containing TMCD and EG residues, the copolyester has at least one of the following properties chosen from: a Tg of from about 100 to about 110° C. as measured by a TA 2100 Thermal Analyst Instrument at a scan rate of 20° C./min, a flexural modulus at 23° C. of equal to or greater than 2000 MPa (about 290,000 psi), or greater than 2200 MPa (319,000 psi) as defined by ASTM D790, a notched Izod impact strength of about 30 J/m (0.56 ft-lb/in) to about 80 J/m (1.50 ft-lb/in) according to ASTM D256 with a 10-mil notch using a ⅛-inch thick bar at 23° C., and less than 5% loss in inherent viscosity after being held at a temperature of 293° C. (560° F.) for 2 minutes. In one embodiment, the L* color values for the polyester composition is 90 or greater, or greater than 90, as determined by the L*a*b* color system measured following ASTM D 6290-98 and ASTM E308-99, performed on polymer granules ground to pass a 1 mm sieve.

In one embodiment, where the outer layers comprise copolyesters containing TMCD and EG residues, the copolyester comprises a diol component having at least 30 mole percent TMCD residues (based on the diols) and a catalyst/stabilizer component comprising: (i) titanium atoms in the range of 10-60 ppm based on polymer weight, (ii) manganese atoms in the range of 10-100 ppm based on polymer weight, and (iii) phosphorus atoms in the range of 10-200 ppm based on polymer weight. In one embodiment, the 2,2,4,4-tetramethyl-1,3-cyclobutanediol residues is a mixture comprising more than 50 mole % of cis-2,2,4,4-tetramethyl-1,3-cyclobutanediol residues and less than 50 mole % of trans-2,2,4,4-tetramethyl-1,3-cyclobutanediol residues.

In certain embodiments, the glycol component for the copolyesters includes but is not limited to at least one of the following combinations of ranges: about 30 to about 40 mole % 2,2,4,4-tetramethyl-1,3-cyclobutanediol and about 60 to 70 mole % ethylene glycol; about 32 to about 40 mole % 2,2,4,4-tetramethyl-1,3-cyclobutanediol and about 60 to 68 mole % ethylene glycol; about 32 to about 38 mole % 2,2,4,4-tetramethyl-1,3-cyclobutanediol and about 64 to 68 mole % ethylene glycol; about 33 to about 40 mole % 2,2,4,4-tetramethyl-1,3-cyclobutanediol and about 60 to 67 mole % ethylene glycol; about 34 to about 40 mole % 2,2,4,4-tetramethyl-1,3-cyclobutanediol and about 60 to 66 mole % ethylene glycol; greater than 34 to about 40 mole % 2,2,4,4-tetramethyl-1,3-cyclobutanediol and 60 to less than 66 mole % ethylene glycol; 34.2 to 40 mole % 2,2,4,4-tetramethyl-1,3-cyclobutanediol and about 60 to 65.8 mole % ethylene glycol; about 35 to about 39 mole % 2,2,4,4-tetramethyl-1,3-cyclobutanediol and about 61 to 65 mole % ethylene glycol; about 35 to about 38 mole % 2,2,4,4-tetramethyl-1,3-cyclobutanediol and about 62 to 65 mole % ethylene glycol; or about 36 to about 37 mole % 2,2,4,4-tetramethyl-1,3-cyclobutanediol and about 63 to 64 mole % ethylene glycol.

In certain embodiments, where the outer layers comprise copolyesters containing TMCD and EG residues, the polyesters may exhibit at least one of the following inherent viscosities as determined in 60/40 (wt/wt) phenol/tetrachloroethane at a concentration of 0.25 g/50 ml at 25° C. from 0.50 to 0.70 dL/g; 0.55 to 0.65 dL/g; 0.56 to 0.64 dL/g; 0.56 to 0.63 dL/g; 0.56 to 0.62 dL/g; 0.56 to 0.61 dL/g; 0.57 to 0.64 dL/g; 0.58 to 0.64 dL/g; 0.57 to 0.63 dL/g; 0.57 to 0.62 dL/g; 0.57 to 0.61 dL/g; 0.58 to 0.60 dL/g or about 0.59 dL/g.

In certain of the embodiments, where the outer layers comprise copolyesters containing TMCD and EG residues, such copolyesters can contain less than 10 mole %, or less than 5 mole %, or less than 4 mole %, or less than 3 mole %, or less than 2 mole %, or less than 1 mole %, or no, CHDM residues.

In embodiments, the polyesters described herein for use in the outer layers may exhibit at least one of the following inherent viscosities as determined in 60/40 (wt/wt) phenol/tetrachloroethane at a concentration of 0.5 g/100 ml at 25° C.: 0.10 to 1.2 dL/g; 0.10 to 1.1 dL/g; 0.10 to 1 dL/g; 0.10 to less than 1 dL/g; 0.10 to 0.98 dL/g; 0.10 to 0.95 dL/g; 0.10 to 0.90 dL/g; 0.10 to 0.85 dL/g; 0.10 to 0.80 dL/g; 0.10 to 0.75 dL/g; 0.10 to less than 0.75 dL/g; 0.10 to 0.72 dL/g; 0.10 to 0.70 dL/g; 0.10 to less than 0.70 dL/g; 0.10 to 0.68 dL/g; 0.10 to less than 0.68 dL/g; 0.10 to 0.65 dL/g; 0.20 to 1.2 dL/g; 0.20 to 1.1 dL/g; 0.20 to 1 dL/g; 0.20 to less than 1 dL/g; 0.20 to 0.98 dL/g; 0.20 to 0.95 dL/g; 0.20 to 0.90 dL/g; 0.20 to 0.85 dL/g; 0.20 to 0.80 dL/g; 0.20 to 0.75 dL/g; 0.20 to less than 0.75 dL/g; 0.20 to 0.72 dL/g; 0.20 to 0.70 dL/g; 0.20 to less than 0.70 dL/g; 0.20 to 0.68 dL/g; 0.20 to less than 0.68 dL/g; 0.20 to 0.65 dL/g; 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dL/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; greater than 0.42 to 1.2 dL/g; greater than 0.42 to 1.1 dL/g; greater than 0.42 to 1 dL/g; greater than 0.42 to less than 1 dL/g; greater than 0.42 to 0.98 dL/g; greater than 0.42 to 0.95 dL/g; greater than 0.42 to 0.90 dL/g; greater than 0.42 to 0.85 dL/g; greater than 0.42 to 0.80 dL/g; greater than 0.42 to 0.75 dL/g; greater than 0.42 to less than 0.75 dL/g; greater than 0.42 to 0.72 dL/g; greater than 0.42 to less than 0.70 dL/g; greater than 0.42 to 0.68 dL/g; greater than 0.42 to less than 0.68 dL/g; and greater than 0.42 to 0.65 dL/g.

For certain embodiments, the polyesters described herein for use in the outer layers may exhibit at least one of the following inherent viscosities as determined in 60/40 (wt/wt) phenol/tetrachloroethane at a concentration of 0.5 g/100 ml at 25° C.: 0.45 to 1.2 dL/g; 0.45 to 1.1 dL/g; 0.45 to 1 dL/g; 0.45 to 0.98 dL/g; 0.45 to 0.95 dL/g; 0.45 to 0.90 dL/g; 0.45 to 0.85 dL/g; 0.45 to 0.80 dL/g; 0.45 to 0.75 dL/g; 0.45 to less than 0.75 dL/g; 0.45 to 0.72 dL/g; 0.45 to 0.70 dL/g; 0.45 to less than 0.70 dL/g; 0.45 to 0.68 dL/g; 0.45 to less than 0.68 dL/g; 0.45 to 0.65 dL/g; 0.50 to 1.2 dL/g; 0.50 to 1.1 dL/g; 0.50 to 1 dL/g; 0.50 to less than 1 dL/g; 0.50 to 0.98 dL/g; 0.50 to 0.95 dL/g; 0.50 to 0.90 dL/g; 0.50 to 0.85 dL/g; 0.50 to 0.80 dL/g; 0.50 to 0.75 dL/g; 0.50 to less than 0.75 dL/g; 0.50 to 0.72 dL/g; 0.50 to 0.70 dL/g; 0.50 to less than 0.70 dL/g; 0.50 to 0.68 dL/g; 0.50 to less than 0.68 dL/g; 0.50 to 0.65 dL/g; 0.55 to 1.2 dL/g; 0.55 to 1.1 dL/g; 0.55 to 1 dL/g; 0.55 to less than 1 dL/g; 0.55 to 0.98 dL/g; 0.55 to 0.95 dL/g; 0.55 to 0.90 dL/g; 0.55 to 0.85 dL/g; 0.55 to 0.80 dL/g; 0.55 to 0.75 dL/g; 0.55 to less than 0.75 dL/g; 0.55 to 0.72 dL/g; 0.55 to 0.70 dL/g; 0.55 to less than 0.70 dL/g; 0.55 to 0.68 dL/g; 0.55 to less than 0.68 dL/g; 0.55 to 0.65 dL/g; 0.58 to 1.2 dL/g; 0.58 to 1.1 dL/g; 0.58 to 1 dL/g; 0.58 to less than 1 dL/g; 0.58 to 0.98 dL/g; 0.58 to 0.95 dL/g; 0.58 to 0.90 dL/g; 0.58 to 0.85 dL/g; 0.58 to 0.80 dL/g; 0.58 to 0.75 dL/g; 0.58 to less than 0.75 dL/g; 0.58 to 0.72 dL/g; 0.58 to 0.70 dL/g; 0.58 to less than 0.70 dL/g; 0.58 to 0.68 dL/g; 0.58 to less than 0.68 dL/g; 0.58 to 0.65 dL/g; 0.60 to 1.2 dL/g; 0.60 to 1.1 dL/g; 0.60 to 1 dL/g; 0.60 to less than 1 dL/g; 0.60 to 0.98 dL/g; 0.60 to 0.95 dL/g; 0.60 to 0.90 dL/g; 0.60 to 0.85 dL/g; 0.60 to 0.80 dL/g; 0.60 to 0.75 dL/g; 0.60 to less than 0.75 dL/g; 0.60 to 0.72 dL/g; 0.60 to 0.70 dL/g; 0.60 to less than 0.70 dL/g; 0.60 to 0.68 dL/g; 0.60 to less than 0.68 dL/g; 0.60 to 0.65 dL/g; 0.65 to 1.2 dL/g; 0.65 to 1.1 dL/g; 0.65 to 1 dL/g; 0.65 to less than 1 dL/g; 0.65 to 0.98 dL/g; 0.65 to 0.95 dL/g; 0.65 to 0.90 dL/g; 0.65 to 0.85 dL/g; 0.65 to 0.80 dL/g; 0.65 to 0.75 dL/g; 0.65 to less than 0.75 dL/g; 0.65 to 0.72 dL/g; 0.65 to 0.70 dL/g; 0.65 to less than 0.70 dL/g; 0.68 to 1.2 dL/g; 0.68 to 1.1 dL/g; 0.68 to 1 dL/g; 0.68 to less than 1 dL/g; 0.68 to 0.98 dL/g; 0.68 to 0.95 dL/g; 0.68 to 0.90 dL/g; 0.68 to 0.85 dL/g; 0.68 to 0.80 dL/g; 0.68 to 0.75 dL/g; 0.68 to less than 0.75 dL/g; 0.68 to 0.72 dL/g; greater than 0.76 dug to 1.2 dL/g; greater than 0.76 dL/g to 1.1 dL/g; greater than 0.76 dL/g to 1 dL/g; greater than 0.76 dL/g to less than 1 dL/g; greater than 0.76 dL/g to 0.98 dL/g; greater than 0.76 dL/g to 0.95 dL/g; greater than 0.76 dL/g to 0.90 dL/g; greater than 0.80 dL/g to 1.2 dL/g; greater than 0.80 dL/g to 1.1 dL/g; greater than 0.80 dL/g to 1 dL/g; greater than 0.80 dL/g to less than 1 dL/g; greater than 0.80 dL/g to 1.2 dL/g; greater than 0.80 dL/g to 0.98 dL/g; greater than 0.80 dL/g to 0.95 dL/g; greater than 0.80 dL/g to 0.90 dL/g.

In embodiments, the inner or core layer can comprise a polyesterether or copolyester ether (COPE), e.g., (PCCE) commercially available, for example, from Eastman Chemical Company. The term “polyesters” as used herein with respect to the inner or core layer, is intended to include copolyesterethers. The copolyesterethers can be derived from a dicarboxylic acid component comprising and/or consisting essentially of 1,4-cyclohexanedicarboxylic acid or an ester forming derivative thereof such as dimethyl-1,4-cyclohexanedicarboxylate. This acid and ester are both sometimes referred to herein as DMCD. The diol component consists essentially of 1,4-cyclohexanedimethanol (CHDM) and polytetramethylene ether glycol (PTMG). The copolyesterethers further can comprise branching agents, for example, from about 0.1 to about 1.5 mole %, based on the acid or glycol component, of a polyfunctional branching agent having at least 3 carboxyl or hydroxyl groups.

In embodiments, the dibasic acid component of the copolyesterether comprises residues of 1,4-cyclohexanedicarboxylic acid or dimethyl-1,4-cyclohexanedicarboxylate having a trans isomer content of at least 70% or at least 80% or at least 85%. In an embodiment, the dibasic acid component of the copolyesterether can consist essentially of DMCD and can have a trans isomer content of at least 70%, or at least 80% or at least 85%.

In embodiments, the polyesterether useful in the core or inner layer can comprise residues of 1,4-cyclohexanedicarboxylic acid or an ester thereof in the amount of from 70-100 weight % or from 80 to 100 weight % or from 90 to 100 weight % or from 95 to 100 weight % or from 98 to 100 weight %, based on a total of 100 weight % acid residues and a total of 100 weight % diol residues. The polyesterether can comprise residues of 1,4-cyclohexanedimethanol and polytetramethylene ether glycol.

In certain embodiments, the polyesterether can comprise residues of from 1 to 50 mole %, or 5 to 50 mole %, or 10 to 50 mole %, or 15 to 50 mole %, or 20 to 50 mole % or 25 to 50 mole %, or 30 to 50 mole %, or 35 to 50 mole %, or 40 to 50 mole %, or 45 to 50 mole %, or 1 to 45 mole %, or 5 to 45 mole %, or 10 to 45 mole %, or 15 to 45 mole %, or 20 to 45 mole % or 25 to 45 mole %, or 30 to 45 mole %, or 35 to 45 mole %, or 40 to 45 mole %, or 1 to 40 mole %, or 5 to 40 mole %, or 10 to 40 mole %, or 15 to 40 mole %, or 20 to 40 mole % or 25 to 40 mole %, or 30 to 40 mole %, or 35 to 40 mole %, or 1 to 35 mole %, or 5 to 35 mole %, or 10 to 35 mole %, or 15 to 35 mole %, or 20 to 35 mole % or 25 to 35 mole %, or 30 to 35 mole %, or 1 to 30 mole %, or 5 to 30 mole %, or 10 to 30 mole %, or 15 to 30 mole %, or 20 to 30 mole % or 25 to 30 mole %, or 1 to 25 mole %, or 5 to 25 mole %, or 10 to 25 mole %, or 15 to 25 mole %, or 20 to 25 mole %, or 1 to 20 mole %, or 5 to 20 mole %, or 10 to 20 mole %, or 15 to 20 mole %, or 1 to 15 mole %, or 5 to 15 mole %, or 10 to 15 mole %, or 1 to 10 mole %, or 5 to 10 mole %, or 1 to 5 mole %, of polytetramethylene ether glycol residues.

In certain embodiments, the polyesterether can comprise residues of from 1 mole % to 20 mole %, or 1 mole % to 15 mole %, or 1 mole % to 12 mole %, or 1 mole % to 10 mole %, or 3 mole % to 12 mole %, or from 5 mole % to 10 weight %, or from 7 to 10 mole %, of polytetramethylene ether glycol residues.

In one embodiment, the polyester portion of the polyesterether comprises residues of at least one glycol as described for the polyesters useful in the invention. In certain embodiments, the polyester portion of the polyesterether comprises residues of at least one glycol selected from ethylene glycol, diethylene glycol, triethylene glycol, isosorbide, propane-1,3-diol, butane-1,4-diol, 2,2-dimethylpropane-1,3-diol (neopentyl glycol), 2,2,4,4,-tetramethyl-1,3-cyclobutanediol, pentane-1,5-diol, hexane-1,6-diol, 1,4-cyclohexanedimethanol, 3-methyl-pentanediol-(2,4), 2-methylpentanediol-(1,4), 2,2,4-tri-methylpentane-diol-(1,3), 2-ethylhexanediol-(1,3), 2,2-diethylpropane-diol-(1,3), hexanediol-(1,3), 1,4-di-(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, 2,2-bis-(4-hydroxypropoxyphenyl)-propane, and mixtures thereof. In embodiments, in addition to polytetramethylene ether glycol (PTMG) residues, the balance of the glycol component of the polyesterether is essentially 1,4-cyclohexanedimethanol (CHDM) residues. In embodiments, the glycol component of the polyesterether comprises less than 10 mole %, or less than 5 mole %, or less than 2 mole %, or less than 1 mole %, of glycol residues other than residues of CHDM and PTMG.

In embodiments, the polyesterether can comprise residues of from 50 weight % to 95 weight %, or from 55 weight % to 95 weight %, or from 60 weight % to 95 weight %, or from 70 weight % to 95 weight %, or from 75 weight % to 95 weight %, or from 80 weight % to 95 weight %, of 1,4-cyclohexanedimethanol residues. In embodiment, the polyesterether does not contain residues of ethylene glycol.

In embodiments, the inner layer comprises a polyesterether having an inherent viscosity (IV) in a range from 0.70 to 1.5 dL/g, or 0.8 to 1.4 dL/g, or 0.9 to 1.3 dL/g, 1.0 to 1.2 dL/g, or 1.1 to 1.2 dL/g, or 1.14 to 1.18 dL/g, as determined in 60/40 (wt/wt) phenol/tetrachloroethane at a concentration of 0.5 g/100 ml at 25° C. In embodiments, the polyesterether has a glass transition temperature (Tg) or less than 0° C., or less than −10° C., or less than −20° C., or less than −30° C., or in the range from −60° C. to 0° C., or −50° C. to −10° C., −60° C. to −20° C., or −50° C. to −30° C., measured by DSC. In embodiments, the polyesterether has an elongation at break of at least 200%, or at least 300%, or at least 350%, or in the range of 200% to 600%, or 300% to 500%, measured according to ASTM D 638; and/or a flexural modulus in the range of 50 to 250 MPa, or 100 to 200 MPa, measured according to ASTM D 790; and/or a tear strength of at least 200 N, or at least 250 N, or at least 300 N, or in the range from 200 N to 500N, or 250 N to 450 N, or 300 N to 400 N, measured according to ASTM D 1004.

In one embodiment, copolyesterether contained in the core or inner layer can have an inherent viscosity of from about 0.70 to about 1.5 dL/g as determined in 60/40 (wt/wt) phenol/tetrachloroethane at a concentration of 0.5 g/100 ml at 25° C. and can comprise:
A. a dicarboxylic acid component comprising and/or consisting essentially of 1,4-cyclohexanedicarboxylic acid, and
B. a glycol component consisting essentially of
   (1) 1,4-cyclohexanedimethanol, and
   (2) from about 1 to about 50 mole percent, or from 1 to 20 mole percent, or from 1 to 15 mole percent, or from 2 to 10 mole percent, based on the moles of the glycol component of the polyesterether, of polytetramethyleneether glycol (PTMG) having a weight average molecular weight of about 500 to about 2000.

In one embodiment, the copolyesterether can further comprise (3) from about 0.1 to about 1.5 mole %, or 0.1 to 1.0 mole % based on the total mole % of the acid or glycol component, of a branching agent having at least three COOH or OH functional groups and from 3 to 60 carbon atoms.

In embodiments, the inner (or core) layer comprises a copolyester having CHDM and EG glycol residues having an inherent viscosity (IV) in a range from 0.5 to 1.0 dL/g, or 0.6 to 0.9 dL/g, or 0.65 to 0.85 dL/g, 0.7 to 0.8 dL/g, as determined in 60/40 (wt/wt) phenol/tetrachloroethane at a concentration of 0.5 g/100 ml at 25° C. In embodiments, the copolyester has a glass transition temperature (Tg) or greater than 60° C., or greater than 70° C., or greater than 75° C., or in the range from 60° C. to 100° C., or 70° C. to 90° C., or 75° C. to 85° C. measured by DSC. In embodiments, the copolyester has an elongation at break of at least 80%, or at least 100%, or at least 120%, or in the range of 80% to 180%, or 100% to 160%, measured according to ASTM D 638; and/or a flexural modulus in the range of 1600 to 2600 MPa, or 1800 to 2400 MPa, or 2000 to 2200 MPa, measured according to ASTM D 790; and/or a tear force of at least 25 N, or at least 30 N, or at least 35 N, or in the range from 25 N to 100N, or 30 N to 80 N, or 35 N to 60 N, measured according to ASTM D 1938.

As noted above, the overall thickness of the sheet can range from about 100 μM to about 3000 μM, or about 300 μM to about 3000 μM. In other embodiments, the thickness of the sheet ranges from about 380 μM to about 1600 μM. In certain embodiments, the thickness of the core layer ranges from about 1 μM to about 1000 μM. In certain embodiments, the thickness of the core layer ranges from about 1 μM to about 725 μM, or 1 μM to 600 μM. In certain embodiments, the thickness of the outer layers each individually range from about 1 μM to about 2000 μM. In a further embodiment, the outer layer thickness ranges from about 25 μM to about 2000 μM.

The multilayer sheets of this invention can be produced by co-extrusion, extrusion laminating, heat laminating, adhesive laminating and the like. In co-extrusion multiple layers of polymers are generated by melting the polymer compositions for each layer in different extruders which are fed into a coextrusion block or die. A multi-layer sheet or film is formed in the block or die. Extrusion laminating is a process in which at least two sheets or films (monolayer or co-ex) are bonded together by extruding a polymer melt between them, creating a multilayer structure. Adhesive laminating takes at least two sheets or films (monolayer or co-ex) and bonds them together using a liquid adhesive to create a multilayer sheet or film. Heat laminating is a batch process in which cut sheets or films of various compositions or structures are laid up in a heated press. Multiple combinations and multiple layers can be made using these methods.

In the event the multilayer sheet having the core and outer layers chosen as described herein tend to separate or delaminate from each other during processing or usage, at least one intermediate “tie layer” may be utilized between such layers. In one embodiment, the multilayer film has at least five film layers comprising one-core layer A and two outer layers B, with one-layer B one each side of the core layer A and a tie layer between the layer A and each layer B, i.e., “B-tie-A-tie-B”. In certain embodiments, such tie layers comprise one or more copolymers selected from polyethylene copolymers, polypropylene copolymers, anhydride modified polyolefins, acid/acrylate modified ethylene vinyl acetate copolymer, acid modified ethylene acrylate, anhydride modified ethylene acrylate, modified ethylene acrylate, modified ethylene vinyl acetate, anhydride modified ethylene vinyl acetate copolymer, anhydride modified high density polyethylene, anhydride modified linear low density polyethylene, anhydride modified low density polyethylene, anhydride modified polypropylene, ethylene ethyl acrylate maleic anhydride copolymer and ethylene butyl acrylate maleic anhydride terpolymer, ethylene-alpha-olefin copolymers, alkene-unsaturated carboxylic acid or carboxylic acid derivative copolymers, ethylene-methacrylic acid copolymers, ethylene-vinyl acetate copolymers, ethylene-methacrylic acid copolymers, unsaturated dicarboxylic acid anhydride grafted copolymers, maleic anhydride grafted ethylene-vinyl acetate copolymers, maleic anhydride grafted polyethylene, styrene-butadiene copolymers, C3 or higher alpha-olefin copolymers having a high alpha-olefin comonomer content, propylene-1-butene copolymers, and mixtures thereof.

In embodiments, the multilayer sheet has a tear force of at least 30 N, or at least 40 N, or at least 45 N, or at least 50 N, or at least 60 N, or at least 65 N, or in a range from 30 N to 100 N, or 40 N to 100 N, or 45 N to 100 N, or 50 N to 90 N, or 60 N to 80 N, measured according to ASTM D 1938; and/or a force retention percent loss of 55% or less, or 50% or less, or a range of 35 to 55%, or 40 to 55%, or 45 to 55%, or 35 to 50%, or 40 to 50%, measured as described in the examples herein; and/or a flexural modulus greater than 1500 MPa, or at least 1550 MPa, or at least 1600 MPa, or in the range of greater than 1500 to 2400 MPa, or greater than 1500 to 2200 MPa, or greater than 1500 to 2100 MPa, or 1550 to 2200 MPa, or 1550 to 2100 MPa, or greater than 1500 to 2000 MPa, or 1550 to 2000 MPa, or 1600 to 2000 MPa, or 1600 to 1800 MPa, measured according to ASTM D 790. In embodiments, the multilayer sheet has both the tear force and force retention properties described above. In embodiments, the multilayer sheet has each of the tear force, force retention and flexural modulus properties described above. In embodiments, the multilayer sheet has a total thickness in the range from 100 to 1050 microns, or 500 to 1050 microns, or 500 to 1000 microns, or 600 to 900 microns, or 600 to 800 microns, or 635 microns (25 mils) to 889 microns (35 mils), or 635 microns (25 mils) to 762 microns (30 mils). In embodiments, the thickness of the inner (or B layer) is from 10 to 50%, or 15 to 45%, or 20 to 40%, or 20 to 35%, or 25 to 35% of the total thickness of the multilayer sheet.

Due to its structure as having customizable modulus and superior tear resistance, the sheets of the invention are useful in preparing removable orthodontic tooth positioning appliances, insofar as the sheets of the invention possess sufficiently high modulus and superior tear resistance. See for example, U.S. Pat. Nos. 9,655,691; 9,655,693; and 10,052,176, incorporated herein by reference.

Accordingly, in a further embodiment, the invention provides a removable orthodontic tooth positioning appliance having teeth receiving cavities shaped to directly receive at least some of a patient's teeth, said appliance comprising a multi-layer polymer structure formed from a sheet comprising at least three layers, said three layers comprising two outer layers and a core layer, wherein
(A) said outer layers are the same or are different and comprise a polyester comprising:
   (a) a dicarboxylic acid component comprising:
      i) 70 to 100 mole % of terephthalic acid residues; and
      ii) 0 to 30 mole % of aromatic and/or aliphatic dicarboxylic acid residues having up to 20 carbon atoms; and
   (b) a glycol component comprising:
      i) 10 to 40 mole % of 2,2,4,4-tetramethyl-1,3-cyclobutanediol residues;
      ii) 0 to 90 mole % of 1,4-cyclohexanedimethanol residues; and
      iii) 0 to 90 mole % of ethylene glycol residues; and
having an inherent viscosity of about 0.4 to about 0.9 dL/g as determined in 60/40 (wt/wt) phenol/tetrachloroethane at a concentration of 0.5 g/100 ml at 25° C.; and
(B) a core layer which comprises a polyester which is other than the polyester in said outer layer, and wherein the overall thickness of the sheet is between 100 and 3000 microns, or 300 and 3000 microns.

In a further embodiment, said outer layer comprises a polyester comprising:
(a) a dicarboxylic acid component comprising:
   i) 90 to 100 mole % of terephthalic acid residues;
   ii) 0 to 10 mole % of aromatic and/or aliphatic dicarboxylic acid residues having up to 20 carbon atoms; and
(b) a glycol component comprising:
   i) 10 to 40 mole % of 2,2,4,4-tetramethyl-1,3-cyclobutanediol residues;
   ii) 60 to 90 mole % of 1,4-cyclohexanedimethanol residues; and
has an inherent viscosity of about 0.5 to about 0.9 dL/g as determined in 60/40 (wt/wt) phenol/tetrachloroethane at a concentration of 0.5 g/100 ml at 25° C.

In a further embodiment, said outer layer comprises a polyester comprising:
(a) a dicarboxylic acid component comprising:
   (i) 90 to 100 mole % of terephthalic acid residues;
   ii) 0 to 10 mole % of aromatic and/or aliphatic dicarboxylic acid residues having up to 20 carbon atoms; and
(b) a glycol component comprising:
   i) 10 to 40 mole % of 2,2,4,4-tetramethyl-1,3-cyclobutanediol residues;
   ii) 60 to 90 mole % of ethylene glycol residues; and
has an inherent viscosity of about 0.4 to about 0.9 dL/g as determined in 60/40 (wt/wt) phenol/tetrachloroethane at a concentration of 0.5 g/100 ml at 25° C. In a further embodiment, the inherent viscosity of the outer layer is between about 0.5 and 0.7 dL/g.

In a further embodiment, the invention provides a removable orthodontic tooth positioning appliance having teeth receiving cavities shaped to directly receive at least some of a patient's teeth, said appliance comprising a multi-layer polymer structure formed from a sheet comprising two outer layers and at least one core layer, wherein said core layer comprises a polyester comprising:
(a) a dicarboxylic acid component comprising:
   i) 90 to100 mole % of trans-1,4-cyclohexane dicarboxylic acid residues;
   ii) 0 to 10 mole % of aromatic and/or aliphatic dicarboxylic acid residues having up to 20 carbon atoms; and
(b) a glycol component comprising:
   i) 15 to 65 mole % of 1,4-cyclohexanedimethanol, and
   ii) 5 to 20 mole % poly(tetramethylene ether)glycol residues;
and has an inherent viscosity of about 0.8 to about 1.4 dL/g as determined in 60/40 (wt/wt) phenol/tetrachloroethane at a concentration of 0.5 g/100 ml at 25° C.

In a further embodiment, said core layer comprises a polyester comprising:
(a) a dicarboxylic acid component comprising:
   i) 90 to 100 mole % of trans-1,4-cyclohexane dicarboxylic acid residues;
   ii) 0 to 10 mole % of aromatic and/or aliphatic dicarboxylic acid residues having up to 20 carbon atoms; and
(b) a glycol component comprising:
   i) 15 to 65 mole % of 1,4-cyclohexanedimethanol residues, and
   ii) 85 to 35 mole % ethylene glycol residues;
and has an inherent viscosity of about 0.4 to about 0.8 dL/g as determined in 60/40 (wt/wt) phenol/tetrachloroethane at a concentration of 0.5 g/100 ml at 25° C. In this embodiment, the moles of the glycol component add up to 100 mole % and may further be comprised of from 0 to 15 mole % of residues of diethylene glycol.

In embodiments, the dental appliance can made from any of the multilayer sheets described herein.

This invention can be further illustrated by the following examples of certain embodiments thereof, although it will be understood that these examples are included merely for purposes of illustration and are not intended to limit the scope of the invention unless otherwise specifically indicated.

### EXAMPLES

Films/sheets were prepared by extruding monolayer films or coextruding multilayer films and testing from the following resins:
Resin 1=Ecdel™ Elastomer 9966
Resin 2=Eastman Tritan™ Copolyester MP100
Resin 3=Eastar™ Copolyester 6763

### Examples 1-3

Three-layer films (having an A-B-A structure) were coextruded using a single screw extruder for the “A” layers, and a single screw extruder for the “B” layer of the films. The “A” layers of the film were made from Resin 2. The “B” layer of the film was made from Resin 1. Extrusion conditions that were used are shown below in table 1.

TABLE 1
Coextrusion Conditions

| Extruder Zone | Extruder A (outer layers) | Extruder B (core layer) |
|---|---|---|
| 1 | 260° C. | 225° C. |
| 2 | 270° C. | 235° C. |
| 3 | 275° C. | 235° C. |
| Adapter | 278° C. | — |
| Die | 282° C. | — |
| Top roll | 50° C. | — |
| Middle roll | 50° C. | — |
| Bottom roll | 30° C. | — |

The thickness of Resin 1 was increased for each example as shown in table 2.

TABLE 2
Thickness of Film Layers

| | Approximate Thickness of B | Total Thickness of Film |
|---|---|---|
| Example | Layer - Resin 1 (microns) | (microns) |
| 1 | 61 | 660 |
| 2 | 193 | 728 |
| 3 | 237 | 725 |

### Comparative Examples 1 and 2

Monolayer films were extruded on a single screw extruder. Comparative example 1 was produced using resin 2, and comparative example 2 was produced using resin 3. Extrusion conditions that were used can be found in table 3 below.

TABLE 3
Extrusion Conditions

| | |
|---|---|
| Zone 1 | 250°-270° C. |
| Zone 2 | 250°-265° C. |
| Zone 3 | 250°-260° C. |
| Zone 4 | 250°-260° C. |
| Zone 5 | 250°-260° C. |
| Die | 260°-270° C. |
| Top roll | 50°-71° C. |
| Middle roll | 45°-66° C. |
| Bottom roll | 30°-43° C. |

The comparative example 1 monolayer film had a thickness of 686 microns and the comparative example 2 monolayer film had a thickness of 762 microns.

### Example 4

A three-layer film was prepared similar to examples 1-3, where the core (layer B) was made from resin 3, and the skin layers (layers A) were made from resin 2. Extrusion conditions that were used are shown below in table 4.

TABLE 4
Coextrusion Conditions

| | Extruder A (outer layers) | Extruder B (core layer) |
|---|---|---|
| Zone 1 | 270° C. | 255° C. |
| Zone 2 | 265° C. | 255° C. |
| Zone 3 | 260° C. | 260° C. |
| Zone 4 | 260° C. | 260° C. |
| Zone 5 | 260° C. | 260° C. |
| Die | 265° C. | — |
| Top roll | 70° C. | — |
| Middle roll | 65° C. | — |
| Bottom roll | 40° C. | — |

The total thickness of the structure was about 762 microns. The core layer was about 710 microns and the outer layers were about 25 microns each.

### Comparative Examples 3 and 4

Comparative example 3 was a monolayer TPU dental aligner material that was commercially available. This material was approximately 762 microns thick and was available in disc form. Comparative example 4 was a monolayer polypropylene material that was commercially available. The thickness of the material was about 1016 microns.

### Test Methods

The films were tested in accordance with ASTM standard test methods for haze, and for flexural and tear properties, as follows:
Flexural modulus—determined using ASTM D790.
Tear strength—determined using ASTM D1938.
Haze measurements were taken according to ASTM D1003.

Force retention properties of the films were determined using dynamic mechanical analysis (DMA) at elevated temperature and humidity. For force retention, the samples were held at 37° C. and 90% RH for 60 min before being displaced at a strain of 0.5% for 24 hours. The temperature and humidity were held constant at 37° C. and 90% RH throughout the duration of the test. The sample dimensions were 3.175 mm wide by approximately 10 mm length. The amount of force, in Newtons, at the beginning of the test was compared to the amount of force remaining after 24 hours. The calculation yielding the percentage loss was determined for each of the films based upon the initial force and the force remaining after 24 hours.

Film thickness measurements for total thickness, as well as the individual layer thickness, of each film was determined using an optical microscope to view the cross-section of each film for a measurement to be taken.

### Test Results

The results of the testing for the various films are listed below in table 5.

TABLE 5
Comparison of properties of the films

| | Comp. | Comp. | | | | | Comp. | Comp. |
|---|---|---|---|---|---|---|---|---|
| Property | Ex. 1 | Ex. 2 | Ex. 1 | Ex. 2 | Ex. 3 | Ex. 4 | Ex. 3 | Ex. 4 |
| Force | 45 | 77 | 55 | 49 | 48 | 73 | 73 | 66 |
| Retention, % | | | | | | | | |
| loss | | | | | | | | |
| Flexural | 2077 | 2443 | 1769 | 1679 | 1644 | 2189 | 2437 | 1334 |
| Modulus, MPa | | | | | | | | |
| Average Tear | 22 | 45 | 14 | 69 | 74 | 44 | 24 | 59 |
| Force, N | | | | | | | | |
| % Haze | 0.9 | 0.7 | — | — | 2.3 | 2.1 | 68.8 | 28.1 |
| Approx. | 686 | 762 | 660 | 728 | 725 | 762 | 762 | 1016 |
| Thickness, | | | | | | | | |
| microns | | | | | | | | |

A review of table 5 reveals that the films of examples 1-3 show improved properties compared to comparative examples 1 and 2. The tear properties for examples 1-3 show improved tear resistance as the thickness of Resin 1 is increased. This shows that the thickness of the core layer can be adjusted to “tune” the product to increase the durability of the structure, depending on needs.

Table 5 also shows that flexural modulus can be tuned by adjusting the layer thickness. The data shows that as the thickness of layer B (Resin 1) increases, the modulus will decrease. Modulus can be selectively adjusted for applications where tougher articles are needed, while maintaining flexibility. Further, if a higher modulus film is desired, the overall structure can be tuned, utilizing a higher modulus material in the core layer, as shown for example 4.

Adding the Resin 3 core (example 4) yields a film that has an increased modulus compared to the Resin 2 monolayer, but also doubled the average tear strength compared to that monolayer. The use of Resin 2 as outer layers also yields a modest improvement in force retention over comparative example 2, which (it is believed) could be further improved by increasing the layer thickness of the resin 2 outer layers and decreasing the thickness of the resin 3 core layer.

Stress relaxation properties of the films were analyzed using dynamic mechanical analysis (DMA) as described above, where the samples were held for 24 hours (at elevated temperature and humidity), during which time the force was measured. The ability of materials to maintain constant force properties over a period of time can be important for certain application, e.g., dental aligner applications. An aligner should maintain its ability to consistently exert force on teeth more effectively when it is able to retain more force over a longer period of time. Table 5 shows that the films of examples 1-3 (especially examples 2 and 3) can retain their force better than the other materials tested (except the resin 2 monolayer). The force retention of the films of examples 1-3 improved with increasing thickness of layer B (Resin 1).

The invention has been described in detail with particular reference to certain embodiments thereof, but it will be understood that variations and modifications can be effected within the spirit and scope of the invention.

1. A multi-layer sheet comprising at least three layers, said three layers comprising two outer layers and a core layer, wherein
(A) said outer layers are the same or are different and comprise a polyester comprising:
(a) a dicarboxylic acid component comprising:
i) 70 to 100 mole % of terephthalic acid residues; and
ii) 0 to 30 mole % of aromatic and/or aliphatic dicarboxylic acid residues having up to 20 carbon atoms; and
(b) a glycol component comprising:
i) 10 to 40 mole % of 2,2,4,4-tetramethyl-1,3-cyclobutanediol residues;
ii) 0 to 90 mole % of 1,4-cyclohexanedimethanol residues; and
iii) 0 to 90 mole % of ethylene glycol residues; and
having an inherent viscosity of about 0.4 to about 0.9 dL/g as determined in 60/40 (wt/wt) phenol/tetrachloroethane at a concentration of 0.5 g/100 ml at 25° C.; and
(B) a core layer which comprises a polyester which is other than the polyester in said outer layer, and wherein the overall thickness of the sheet is between 100 and 3000 microns.

2. The sheet according to claim 1, wherein
(A) said outer layers are the same or are different and comprise a polyester comprising:
(a) a dicarboxylic acid component comprising:
i) 90 to 100 mole % of terephthalic acid residues;
ii) 0 to 10 mole % of aromatic and/or aliphatic dicarboxylic acid residues having up to 20 carbon atoms; and
(b) a glycol component comprising:
i) 10 to 40 mole % of 2,2,4,4-tetramethyl-1,3-cyclobutanediol residues;
ii) 60 to 90 mole % of 1,4-cyclohexanedimethanol residues; and
has an inherent viscosity of about 0.5 to about 0.9 dL/g, or 0.6 and 0.8 dL/g, as determined in 60/40 (wt/wt) phenol/tetrachloroethane at a concentration of 0.5 g/100 ml at 25° C.;
(B) a core layer which comprises a polyester which is other than the polyester in said outer layer, and wherein the overall thickness of the sheet is between 100 and 3000 microns.

3. The sheet according to claim 1, wherein
(A) said outer layers are the same or are different and comprise a polyester comprising:
(a) a dicarboxylic acid component comprising:
i) 90 to 100 mole % of terephthalic acid residues;
ii) 0 to 10 mole % of aromatic and/or aliphatic dicarboxylic acid residues having up to 20 carbon atoms; and
(b) a glycol component comprising:
i) 10 to 40 mole % of 2,2,4,4-tetramethyl-1,3-cyclobutanediol residues;
ii) 60 to 90 mole % of ethylene glycol residues; and
has an inherent viscosity of about 0.4 to about 0.9 dL/g, or 0.5 and 0.7 dL/g, as determined in 60/40 (wt/wt) phenol/tetrachloroethane at a concentration of 0.5 g/100 ml at 25° C.; and
(B) a core layer which comprises a polyester which is other than the polyester in said outer layer, and wherein the overall thickness of the sheet is between 100 and 3000 microns.

4. The sheet according to claim 1, wherein the core layer is comprised of a polyester chosen from: (i) a polyesterether that comprises residues of trans-1,4-cyclohexane dicarboxylate, 1,4-cyclohexanedimethanol, and poly(tetramethylene ether) glycol, or (ii) a polyester that comprises residues of terephthalic acid, 1,4-cyclohexanedimethanol, and ethylene glycol.

5. The sheet according to claim 4, wherein the core layer comprises a polyesterether comprising
(a) a dicarboxylic acid component comprising:
i) 90 to 100 mole % of trans-1,4-cyclohexane dicarboxylic acid residues;
ii) 0 to 10 mole % of aromatic and/or aliphatic dicarboxylic acid residues having up to 20 carbon atoms; and
(b) a glycol component comprising:
i) 95 to 80 mole % of 1,4-cyclohexanedimethanol residues, and
ii) 5 to 20 mole % of poly(tetramethylene ether)glycol residues; and
has an inherent viscosity of about 0.9 to about 1.4 dL/g, or 1.02 to about 1.26 dL/g, as determined in 60/40 (wt/wt) phenol/tetrachloroethane at a concentration of 0.5 g/100 ml at 25° C.

6. The sheet according to claim 4, wherein the core layer comprises a copolyester comprising:
(a) a dicarboxylic acid component comprising:
i) 90 to 100 mole % of trans-1,4-cyclohexane dicarboxylic acid residues;
ii) 0 to 10 mole % of aromatic and/or aliphatic dicarboxylic acid residues having up to 20 carbon atoms; and
(b) a glycol component comprising:
i) 15 to 65 mole % of 1,4-cyclohexanedimethanol residues, and
ii) 85 to 35 mole % ethylene glycol residues;
and has an inherent viscosity of about 0.4 to about 0.8 dL/g as determined in 60/40 (wt/wt) phenol/tetrachloroethane at a concentration of 0.5 g/100 ml at 25° C.

7. The sheet according to claim 4, wherein the sheet has a total thickness from about 100 μM to about 3000 μM, and wherein the core layer has a thickness of about 1 μM to about 1050 μM.

8. The sheet according to claim 7, wherein the outer layers each individually have a thickness of from 25 μM to about 2000 μM.

9. The sheet according to claim 4, wherein the sheet has a tear force of at least 30 N, measured according to ASTM D 1938, and a force retention percent loss of 55% or less, measured as described in the specification.

10. The sheet according to claim 9, wherein the sheet has a tear force in a range from 30 N to 100 N, measured according to ASTM D 1938, and a force retention percent loss in the range of 40 to 55%, measured as described in the specification.

11. The sheet according to claim 10, wherein the sheet has a flexural modulus greater than 1500 MPa, measured according to ASTM D 638.

12. The sheet according to claim 11, wherein the sheet has a flexural modulus in a range from greater than 1500 to 2100 MPa, measured according to ASTM D 638.

13. A removable orthodontic tooth positioning appliance having teeth receiving cavities shaped to directly receive at least some of a patient's teeth, said appliance comprising a multi-layer sheet according to claim 12.

14. The appliance according to claim 13, wherein the outer layers of said sheet comprise a polyester comprising:
(a) a dicarboxylic acid component comprising:
i) 90 to 100 mole % of terephthalic acid residues;
ii) 0 to 10 mole % of aromatic and/or aliphatic dicarboxylic acid residues having up to 20 carbon atoms; and
(b) a glycol component comprising:
i) 10 to 40 mole % of 2,2,4,4-tetramethyl-1,3-cyclobutanediol residues;
ii) 60 to 90 mole % of 1,4-cyclohexanedimethanol residues; and
having an inherent viscosity of about 0.5 to about 0.9 dL/g as determined in 60/40 (wt/wt) phenol/tetrachloroethane at a concentration of 0.5 g/100 ml at 25° C.;
wherein the at least one core layer of said sheet comprises a polyesterether comprising:
(a) a dicarboxylic acid component comprising:
i) 90 to100 mole % of trans-1,4-cyclohexane dicarboxyic acid residues;
ii) 0 to 10 mole % of aromatic and/or aliphatic dicarboxylic acid residues having up to 20 carbon atoms; and
(b) a glycol component comprising:
i) 95 to 80 mole % of 1,4-cyclohexanedimethanol residues, and
ii) 5 to 20 mole % of poly(tetramethylene ether)glycol residues; and
having an inherent viscosity of 1.02 to 1.26 dL/g as determined in 60/40 (wt/wt) phenol/tetrachloroethane at a concentration of 0.5 g/100 ml at 25° C.; and
wherein said sheet has a tear force in a range from 45 N to 100 N, measured according to ASTM D 1938, a force retention percent loss in the range of 40 to 55%, measured as described in the specification, and a flexural modulus in a range from greater than 1500 to 2100 MPa, measured according to ASTM D 638.
